(19) United States
(12) Patent Application Publication
(10) Pub. No.: US 2018/0007625 A1
(43) Pub. Date: Jan. 4, 2018

(54) SELECTIVE SCHEDULING GRANT REJECTION FOR SPECTRUM SHARING IN A WIRELESS NETWORK

(71) Applicant: NOKIA SOLUTIONS AND NETWORKS OY, Espoo (FI)

(72) Inventors: Ling YU, Kauniainen (FI); Vinh VAN PHAN, Oulu (FI); Kari Veikko HORNEMAN, Oulu (FI)

(21) Appl. No.: 15/543,213

(22) PCT Filed: Jan. 16, 2015
(86) PCT No.: PCT/EP2015/050772

§ 371 Date: Jul. 12, 2017

(51) Int. Cl. H04W 48/20; H04W 72/14; H04W 48/12

(52) U.S. Cl. CPC H04W 48/20; H04W 48/12; H04W 72/14

(57) ABSTRACT

An example technique may include controlling receiving, by a user device from a serving cell, a first control information including a scheduling grant that identifies a resource to be used for communication between the user device and the serving cell, controlling receiving, by the user device, at least a part of a second control information from one or more other cells that are not serving the user device, and determining, by the user device, whether or not to reject the scheduling grant from the serving cell based on at least the first control information received from the serving cell and the part of the second control information received from the one or more other cells that are not serving the user device.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments. 5G (or fifth generation) wireless network technology is also being developed.

### SUMMARY

According to an example implementation, a method may include controlling receiving, by a user device from a serving cell, a first control information including a scheduling grant that identifies a resource to be used for communication between the user device and the serving cell, controlling receiving, by the user device, at least a part of a second control information from one or more other cells that are not serving the user device, and determining, by the user device, whether or not to reject the scheduling grant from the serving cell based on at least the first control information received from the serving cell and the part of the second control information received from the one or more other cells that are not serving the user device.

According to another example implementation, an apparatus may include at least one processor and at least one memory including computer instructions, when executed by the at least one processor, cause the apparatus to: control receiving, by a user device from a serving cell, a first control information including a scheduling grant that identifies a resource to be used for communication between the user device and the serving cell, control receiving, by the user device, at least a part of a second control information from one or more other cells that are not serving the user device, and determine, by the user device, whether or not to reject the scheduling grant from the serving cell based on at least the first control information received from the serving cell and the part of the second control information received from the one or more other cells that are not serving the user device.

According to another example implementation, a computer program product may include a computer-readable storage medium and storing executable code that, when executed by at least one data processing apparatus, is configured to cause the at least one data processing apparatus to perform a method including: controlling receiving, by a user device from a serving cell, a first control information including a scheduling grant that identifies a resource to be used for communication between the user device and the serving cell, controlling receiving, by the user device, at least a part of a second control information from one or more other cells that are not serving the user device, and determining, by the user device, whether or not to reject the scheduling grant from the serving cell based on at least the first control information received from the serving cell and the part of the second control information received from the one or more other cells that are not serving the user device.

According to another implementation, an apparatus may include means for controlling receiving, by a user device from a serving cell, a first control information including a scheduling grant that identifies a resource to be used for communication between the user device and the serving cell, means for controlling receiving, by the user device, at least a part of a second control information from one or more other cells that are not serving the user device, and means for determining, by the user device, whether or not to reject the scheduling grant from the serving cell based on at least the first control information received from the serving cell and the part of the second control information received from the one or more other cells that are not serving the user device.

According to another example implementation, a method may include controlling sending, by a serving cell, a control information including a scheduling grant that identifies a resource to be used for communication between the cell and a user device, wherein the scheduling grant may be rejected by the user device, and determining by the serving cell whether or not the scheduling grant has been rejected by the user device.

According to another example implementation, an apparatus may include at least one processor and at least one memory including computer instructions, when executed by the at least one processor, cause the apparatus to: control sending, by a serving cell, a control information including a scheduling grant that identifies a resource to be used for communication between the cell and a user device, wherein the scheduling grant may be rejected by the user device, and determine by the serving cell whether or not the scheduling grant has been rejected by the user device.

According to another example implementation, a computer program product may include a computer-readable storage medium and storing executable code that, when executed by at least one data processing apparatus, is configured to cause the at least one data processing apparatus to perform a method including: controlling sending, by a serving cell, a control information including a scheduling grant that identifies a resource to be used for communication between the cell and a user device, wherein the scheduling grant may be rejected by the user device, and determining by the serving cell whether or not the scheduling grant has been rejected by the user device.

According to another example implementation, an apparatus may include means for controlling sending, by a serving cell, a control information including a scheduling grant that identifies a resource to be used for communication between the cell and a user device, wherein the scheduling grant may be rejected by the user device, and means for determining by the serving cell whether or not the scheduling grant has been rejected by the user device.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating a subframe according to an example implementation.

FIG. 3 is a flow chart illustrating operation of a user device according to an example implementation.

FIG. 4 is a flow chart illustrating operation of a serving cell or serving base station according to an example implementation.

FIG. 5 is a block diagram of a wireless station (e.g., BS or user device) according to an example implementation.

### DETAILED DESCRIPTION

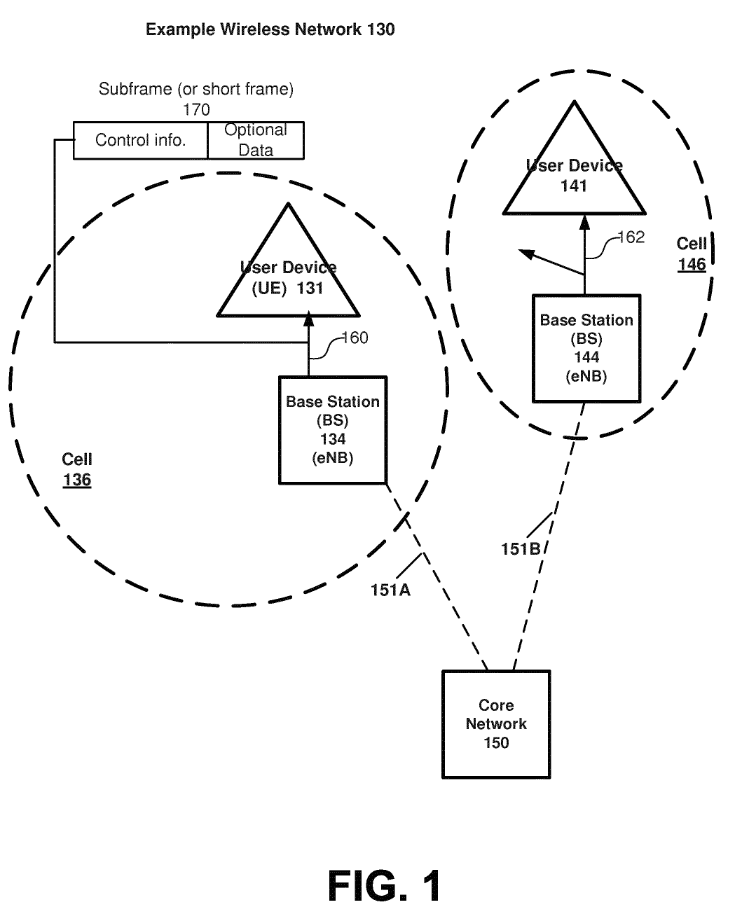

FIG. 1 is a block diagram of a wireless network 130 according to an example implementation. In the wireless network 130 of FIG. 1, user device 131 may be connected to (and in communication) with a base station (BS) 134, which may also be referred to as an enhanced Node B (eNB). BS 134 provides wireless coverage (or wireless communications services) within a cell 136, including to user device 131. Other user devices (not shown) may also be in communication with BS 134 and cell 136. Therefore, with respect to user device 131, cell 136 and BS 134 may be considered to be a serving cell/serving BS because cell 136/BS 134 provide wireless services to user device 131. Similarly, BS 144 provides wireless coverage within a cell 146 to one or more user devices, including to user device 141. With respect to user device 131, cell 146/BS 144 may be considered a non-serving (or neighbor) cell/BS, since cell 146/BS 144 do not provide wireless services to user device 131. Rather, cell 146 is a non-serving cell because cell 146 does not serve or provide wireless services to user device 131. Also, cell 146 is a neighbor cell to user device 131 and cell 136 because cell 146 is adjacent to cell 136, where a neighbor cell may be a cell that is adjacent or near another cell. BS 134 is also connected to a core network 150 via a 51 interface 151A, and BS 144 is connected to core network 150 via 51 interface 151B. In an example implementation, at least part of the functionalities of a base station or (e)Node B (eNB) may be also be carried out by any node, server or host which may be operably coupled to a transceiver, such as a remote radio head. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. LTE is one example technology, but this disclosure and claims are not limited to LTE, and may be applied to any wireless technology including 5G.

According to an example implementation, wireless resources (or network resources) may be shared among multiple base stations (BSs) or Access Nodes (ANs). In an illustrative example, dynamic spectrum/resource sharing maybe performed in an ultra-dense network (UDN) deployment for single or multi-operator arrangements in which dynamic sharing among ANs or BSs may allow for greater throughput or higher data rates. In a scenario in which wireless resources are shared among a plurality of adjacent or nearby Access Nodes (ANs) or Base Stations (BSs), connections may be provided between ANs/BSs to allow the ANs/BSs to coordinate the sharing of wireless resources. In another example implementation of wireless resource sharing, no direct communication may necessarily be provided or performed between ANs or BSs with respect to the coordination of the sharing of resources. However, a problem can arise in resource sharing if two adjacent cells schedule the same resource(s) for use within the same subframe or scheduling unit. In that situation, it is possible that transmissions on the same wireless resources at the same time or within the same subframe may interfere with each other if the cells are neighbor cells or are in sufficient proximity to each other.

Therefore, according to an example implementation, various techniques are described herein to control or reduce the amount of wireless/radio interference between cells in the case of wireless resource/spectrum sharing among a plurality of cells or base stations. According to an example implementation, a user device may receive a first control information from a serving cell that may include a scheduling grant that identifies a resource(s), such as one or more physical resource blocks (PRBs), allocated for the user device to use for communicating with the serving cell/BS. PRBs may include, for example, one or more orthogonal frequency division multiplexing (OFDM) symbols, although other resources may be used as well. The scheduling grant may include an uplink (UL) scheduling grant to allow the user device to send data to a serving cell/BS, or a downlink (DL) scheduling grant to allow the user device to receive data from the serving cell or BS.

According to an example implementation, a user device 131 may receive, from a serving cell/BS, a first control information including a scheduling grant that identifies a resource to be used for communication (e.g., either uplink or downlink communication) between the user device and the serving cell/BS. The user device may also receive at least a part of a second control information from a neighbor cell that is not serving the user device (non-serving cell), or may receive at least a part of a second control information from each of a plurality of non-serving cells. The user device may determine whether or not to reject the scheduling grant based on the first control information received from the serving cell/BS and the part of the second control information received from the non-serving (or neighbor) cell/BS.

For example, as shown in FIG. 1, a user device 131 may receive a subframe 170 via line 160 from serving cell 136/serving BS 134. The subframe 170 received by user device 131 via line 160 from the serving cell 136 may include a first control information (which may include a scheduling grant for the user device 131) and a data portion. The user device 131 may also receive or detect from non-serving cell 146/non-serving BS 144 via line 162 at least a portion of another subframe 170, including receiving at least a part of a second control information from the non-serving cell 146/non-serving BS 144. For example, the part of the second control information received from the non-serving cell 146/non-serving BS 144 may include one or more scheduling grants to one or more other user devices (e.g., user device 141) within cell 146, including an identification of resources or PRBs allocated for one or more scheduling grants within the non-serving cell. In one illustrative example implementation, the resource information (identification of allocated resources/PRBs) in the scheduling grant and the resource information in the second control information may be used by the user device 131 to determine whether or not to reject the scheduling grant, e.g., based on an overlap or use conflict between these allocated resources for the two cells.

In an example implementation, the first control information may be sent via a PDCCH (physical downlink control channel) in one or more subframes of 1 ms (for example) without the data portion.

In another example implementation, the user device 131 may detect other information in the second control information, such as a DL/UL configuration information for the subframe, a total number of resources allocated or a resource usage count for the subframe, and/or other information, which may be used by the user device 131 to make a determination whether or not to reject the scheduling grant, as described in greater detail hereinbelow. In one illustrative example implementation, subframe 170 may be a short frame.

For example, the user device may determine to reject the scheduling grant received from the serving cell/BS based on an overlap or conflict (or possible or likely overlap or conflict) between the resource(s) identified by the scheduling grant from the serving cell and a resource(s) identified in the second control information that has been allocated or scheduled during a same time interval or subframe. Thus, for example, if a first resource (e.g., a time-frequency resource, such as an OFDM symbol(s)) has been allocated or scheduled in a scheduling grant to the user device (e.g., based on the received first control information), and the user device determines (e.g., based on the received second control information) that the first resource has also been allocated or scheduled for communication by a neighbor or adjacent cell/BS (e.g., same OFDM symbol(s), same PRB(s)), then the user device may reject the scheduling grant to avoid interference between the serving cell and the neighbor cell. As described in greater detail below, a variety of different techniques or criteria may be used by a user device to determine whether or not to reject a scheduling grant. Also, the user device may use different techniques to reject a scheduling grant, e.g., by controlling sending a message that explicitly rejects the scheduling grant and/or by implicit rejection of the scheduling grant.

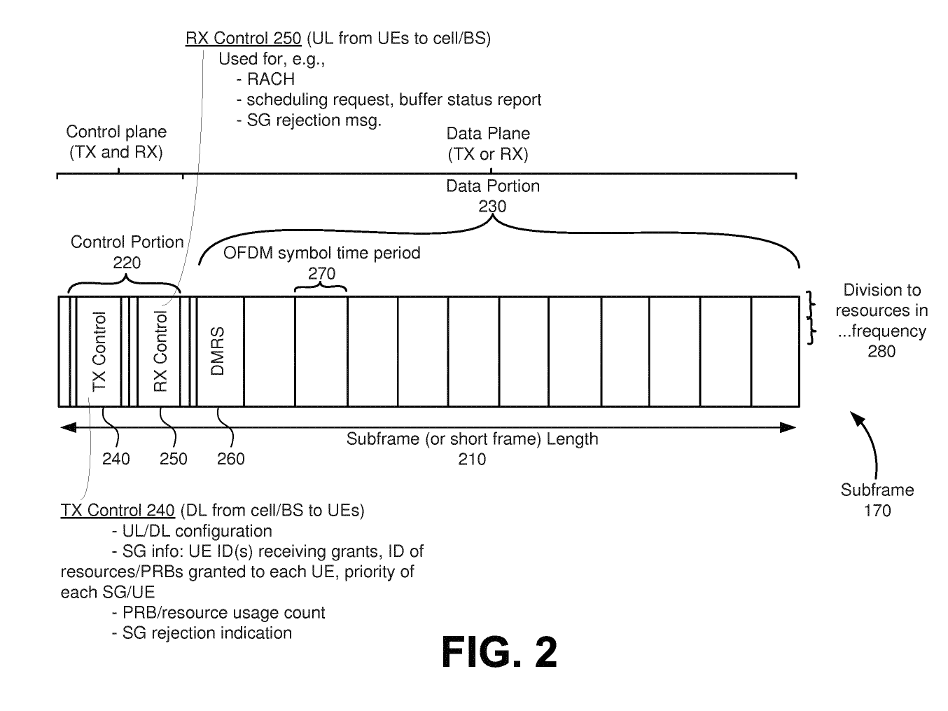

FIG. 2 is a diagram illustrating a subframe 170 according to an example implementation. As shown in the example subframe shown in FIG. 2, subframe 170 may have a subframe length 210, and may include a control portion 220 and a data portion 230. Control portion 220 may include control information, such as a transmit (TX) control information 240 and receive (RX) control information 250. Demodulation reference signals (DMRS) 260 are transmitted by the BS/cell, and may be considered part of the data portion 230, for example. Data portion 230 may include a number of resources, such as a plurality of OFDM symbols 270 or PRBs. A division in frequency 280 is shown for multiple OFDM symbols (OFDM symbols 280 having different frequencies) or resources, as an example.

In one example implementation, a frame may include a plurality of subframes (or other scheduling units). For example, each subframe 170 may be 1 ms in length, or other time interval. As shown in FIG. 2, each subframe may include a control portion 220 that includes resources for the transmission of control information, and a data portion that may include resources for the transmission of data. According to an example implementation, each subframe 170 may be either configured for uplink data transmission (where all data resources in the subframe are provided for uplink data transmission) or downlink data transmission (where all data resources in the subframe are provided for downlink data transmission). For example, this subframe configuration may be referred to as a downlink/uplink (DL/UL) configuration that indicates whether the data portion 230 of the subframe is configured for uplink (from user device to cell/BS) data transmission or downlink (from cell/BS to user device) data transmission.

According to an example implementation, as noted above, subframe 170 may include a control portion 220 that includes control information. The control information may include a TX control information 240 (e.g., which may include control signals/information transmitted from the cell/BS to user device(s)), and a RX control information 250 (e.g., which may include control signals/information transmitted by the user device(s) to the cell/BS). According to an illustrative example implementation, TX control information 240 may include one or more fields, such as, for example: an UL/DL configuration identifying whether the data portion 230 is configured for either UL or DL data transmission; one or more user device (or UE) identifiers that identify user devices /UEs for which a scheduling grant or resources are allocated or provided within the subframe; a list of allocated resources, e.g., identification of PRBs or OFDM symbols that are allocated to each user device for the scheduling grants; a priority for each scheduling grant or user device; a resource (e.g., PRB or OFDM symbol) usage count, which may identify the total amount of resources (or total number of PRBs or OFDM symbols) allocated for a subframe; a scheduling grant (SG) rejection indication that indicates whether or not a scheduling grant may be rejected by a user device, and/or other fields or information. For example, the SG rejection indication may be provided via common control signaling that is directed or communicated to all user devices, or provided/communicated via dedicated signaling to a specific user device(s).

In an example implementation, the RX control information 250 may include information transmitted by a user device to the cell/BS. For example, a user device may use the RX control information 250 to transmit a random access request to the cell/BS, a scheduling request (e.g., to request a scheduling grant for uplink resources to transmit data to the cell) or a buffer status report to report a status of one or more transmission buffers from a user device (e.g., indicating a level of fullness of the data buffer), a scheduling grant rejection message, or other information or signals.

According to an example implementation, a user device 131 (FIG. 1) may receive a scheduling grant, which may be a grant or allocation of resources for uplink transmission from the user device 131 to the serving cell 136/serving BS 134, or a grant or allocation of resources for the serving cell 136/serving BS 134 to transmit data to the user device 131. According to an example implementation, the scheduling grant may be communicated from the serving cell 136/serving BS 134 to the user device via TX control information 240. A scheduling grant may include (or may identify), for example, a user device ID that identifies the user device or UE for which the scheduling grant is provided, and an identification of a resource (e.g., PRB(s), OFDM symbol(s)) allocated to the identified user device for the communication of data/information.

A number of different techniques, criteria or factors may be used by a user device to determine whether or not to reject a scheduling grant. As noted above, according to an example illustrative implementation, a user device may reject a scheduling grant in order to avoid (or at least decrease the probability of) interference with a neighbor cell/BS that is not serving the user device. For example, a potential or prospective interference (e.g., based on scheduling grants) may be detected by a user device when a user device receives a scheduling grant for a resource that has also been scheduled for use by a neighbor or non-serving cell 146/non-serving BS 144. Various fields or information may be considered by a user device when determining whether or not to reject a scheduling grant. According to an example implementation, in some situations, a user device may reject a scheduling grant when an interference or prospective/potential interference is detected by the user device. Further example details are described herein.

According to an example implementation, a user device 131 may receive (or control receiving) a first control information from a serving cell 136/serving BS 134. The first control information may include a scheduling grant (or scheduling grant information). The scheduling grant may be provided for uplink communication (e.g., granting a request to the user device for resources to allow the user device to transmit data to the serving cell 136/serving BS 134) or for downlink communication (e.g., allocating resources for the user device 131 to receive data sent/transmitted from the serving cell 136/serving BS 134).

For example, the scheduling grant may include one or more of: a user device identification (user device ID) or UE ID that identifies the user device 131 to which the scheduling grant is provided/allocated, information identifying one or more resources (e.g., one or more PRBs, one or more OFDM symbols) that are allocated to the identified user device 131 as part of the scheduling grant, a priority of the scheduling grant, a scheduling grant (SG) rejection indication indicating whether or not the SG may be rejected by the user device, and/or other information. As noted above, the subframe that includes the scheduling grant may also include a DL/UL configuration that identifies a data portion 230 of the subframe as being configured for UL communications or DL communications.

The user device 131 may also receive a second control information from one or more other (neighbor or non-serving) cells/BSs, such as from a non-serving cell 146/non-serving BS 144. The second control information may be received by the user device 131 via a subframe received from a neighbor or non-serving cell 146/non-serving BS 144. The second control information may, at least in some cases, include information that may be the same type or a similar type of information that is included in the first control information, but the second control information may include information provided with respect to a non-serving (neighbor) cell, including scheduling grant information for scheduling grants to user devices (e.g., user device 141) within or connected to the neighbor cell 146/neighbor BS 144. Thus, for example, the second control information, e.g., from neighbor or non-serving cell 146/BS 144 may include a list of user device IDs (such as a user device ID of user device 141), identification of one or more resources that are allocated to each of the identified user device(s) as part of the scheduling grant(s) within the neighbor or non-serving cell 146/BS 144, a priority of each of the scheduling grants, a SG rejection indication indicating whether or not the SG may be rejected by the user device, and/or other information. The subframe transmitted by the neighbor or non-serving cell 146/BS 144 may also similarly include a DL/UL configuration that identifies a data portion 230 of the subframe as being configured for UL communications or DL communications.

In addition, user device 131 may determine a signal strength and/or a signal quality of signals (e.g., the DMRS/reference signals or other signals) received from serving cell 136/serving BS 134. For example, the signal quality may include one or more of a signal error rate, bit error rate, packet error rate, and/or signal-to-noise ratio. Similarly, user device 131 may also determine a signal strength and/or signal quality of signals received from one or more neighbor (or non-serving) cells/BSs.

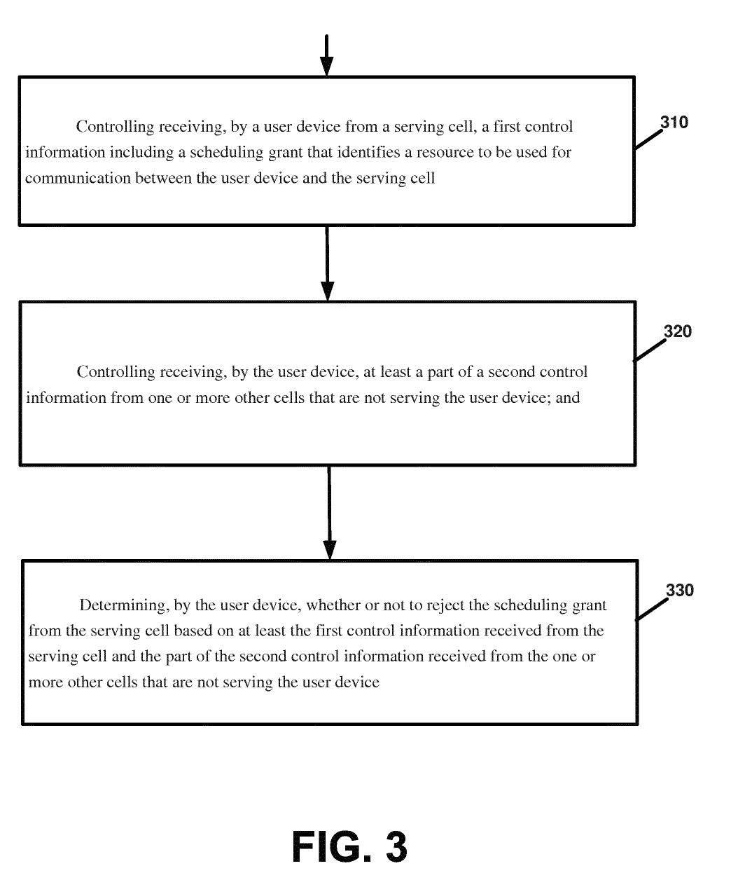

FIG. 3 is a flow chart illustrating operation of a user device according to an example implementation. Operation 310 may include controlling receiving, by a user device (e.g., user device 131) from a serving cell (e.g., from serving cell 136/BS 134), a first control information including a scheduling grant that identifies a resource to be used for communication between the user device and the serving cell. Operation 320 includes controlling receiving, by the user device (e.g., user device 131), at least a part of a second control information from one or more other cells (e.g., from neighbor/non-serving cell 146/BS 144) that are not serving the user device. Operation 330 may include determining, by the user device (e.g., user device 131), whether or not to reject the scheduling grant from the serving cell based on at least the first control information received from the serving cell and the part of the second control information received from the one or more other cells that are not serving the user device.

According to an example implementation, the user device may determine whether or not to reject the scheduling grant based on a conflict or overlap between the resource identified by the scheduling grant from the serving cell and a resource identified in the second control information from one or more of the other cells that are not serving the user device. For example, the user device may determine if a conflict or overlap exists between the resource identified by the scheduling grant from the serving cell and a resource identified in the second control information from one or more of the other cells based on pre-configured rules (e.g., based on priority, signal strength, signal quality, and/or other criteria for the current cell and the other cells) and/or based on monitoring the contents of the contents of the first and second control informations. For example, one or more fields of the first and second control informations (such as grant priority) and/or one or more signal parameters, e.g., signal strength or quality between cells may be compared by a user device to a set of decision rules to allow the user device to make a decision of whether to accept or reject a scheduling grant.

According to an example implementation, the resources identified by the first and second control information may include, for example, time/frequency resources, such as one or more Physical Resource Blocks (PRBs) or one or more OFDM symbols. The scheduling grant may identify an uplink resource (a resource configured for uplink communications from the user device to the serving cell/BS) or a downlink resource (e.g., a resource configured for downlink communications from the serving cell/BS to the user device).

If a user device determines not to reject the scheduling grant, then the user device may use the identified resource(s) for communicating with the serving cell/BS, such as either receiving (or controlling receiving) data from the serving cell/BS via the identified downlink resource (in the case of a scheduling grant for downlink communications), or transmitting (or controlling transmitting) data to the serving cell/BS via the identified uplink resource (in the case of a scheduling grant for uplink communications).

If a user device determines (or makes a decision) to reject the scheduling grant it received from the serving cell/BS, then the user device may reject the scheduling grant using a variety of different techniques. For example, in the case of a scheduling grant that identifies uplink resources (resources for uplink communications from user device to the serving cell/BS), the user device may mute itself by not transmitting on the resources identified by the scheduling grant, which is an implicit rejection of the scheduling grant. Also, the user device may explicitly reject (or provide an explicit indication of a rejection of the scheduling grant) by sending to the serving cell/BS a message that indicates a scheduling grant rejection, a scheduling request that requests resources for uplink data transmission, or a buffer status report that may indicate a level of fullness or data to be transmitted to the serving cell/BS.

According to an example implementation, in the case of a scheduling grant that identifies downlink resources (resources for downlink transmission from the serving cell to the user device), the user device may reject such downlink scheduling grant by sending an explicit scheduling grant rejection (e.g., scheduling grant rejection message, buffer status report, or scheduling request). For example, in the case of a downlink scheduling grant, an implicit scheduling grant rejection where the user device does not use the identified resource for communication may typically not be sufficient to reject the downlink scheduling grant. Thus, according to an example implementation, an explicit rejection may typically be used to reject a downlink scheduling grant. This is because, in the absence of the explicit rejection of the scheduling grant, the serving cell/BS will transmit data to the user device via the resource of the downlink scheduling grant, for example.

In the case where a serving cell/BS detects a rejection of a scheduling grant (e.g., based on a message that may explicitly reject the scheduling grant, or by the muting or non-transmission of data in the case of an uplink scheduling grant) by a user device, the serving cell/BS may increase a priority of the user device to receive further resources, and/or may allocate a new resource and/or send to the user device a new scheduling grant that identifies a new resource, e.g., to replace the rejected scheduling grant.

Referring to the method of FIG. 3, according to an example implementation, if the scheduling grant identifies an uplink resource to be used for the user device to communicate with the serving cell, the determining may include determining to reject the scheduling grant. Also, the method of FIG. 3 may further include rejecting the uplink scheduling grant by the user device not transmitting data to the serving cell via the uplink resource identified by the scheduling grant. This may be referred to as the user device muting itself, e.g., to avoid interference with a neighbor cell.

Referring to the method of FIG. 3, according to an example implementation, if the scheduling grant identifies an uplink resource to be used for the user device to communicate with the serving cell, the determining may include determining to reject the scheduling grant. The method of FIG. 3 may further include rejecting the uplink scheduling grant by the user device controlling sending a scheduling grant request or a buffer status report indicating data for transmission to the serving cell.

Referring to the method of FIG. 3, according to an example implementation, if the scheduling grant identifies a downlink resource to be used for the user device to receive data from the serving cell, the determining may include determining to reject the scheduling grant. According to an example implementation, the method of FIG. 3 may further include rejecting the scheduling grant by the user device controlling sending a message rejecting the scheduling grant to the serving cell.

Referring to the method of FIG. 3, according to an example implementation, the determining may include determining, by the user device, not to reject the scheduling grant from the serving cell. In addition, the method of FIG. 3 may further include using, by the user device, the resource identified by the scheduling grant to communicate with the serving cell (e.g., to send/transmit or controlling sending data to the serving cell via the identified resource, or receiving/controlling receive data from the serving cell via the identified resource).

A variety of different criteria, factors, or techniques may be used by a user device to determine whether or not to reject a scheduling grant. Some illustrative examples or example techniques will be described below. For example, one or more of the following may be used by the user device to determine whether or not to reject the scheduling grant: 1) a DL/UL configuration of a subframe for the serving cell for a first time interval and/or a DL/UL configuration of a subframe of a neighbor/non-serving cell for the same first time interval; 2) reference signal received power (RSRP) and/or reference signal receives quality (RSRQ) or signal quality of reference signals (e.g., DMRS signals) received from the serving cell and/or from the one or more neighbor/non-serving cells; 3) a priority of a scheduling grant received from a serving cell, and/or a priority of a resource allocation or scheduling grant received from a neighbor (non-serving) cell provided to another user device (e.g., as indicated by a second control information; 4) the specific resource allocations or specific resources (PRBs, OFDM symbols) allocated for use in a scheduling grant by a serving cell and by one or more neighbor/non-serving cells, and whether there is a conflict or overlap in the resources allocated or identified in scheduling grants between the serving cell and one or more neighbor/non-serving cells; and/or 5) a total amount of resources and/or a total amount of high priority resources scheduled or allocated for a subframe or time interval by the serving cell and/or by one or more neighbor/non-serving cells. These are some example factors or criteria, and other factors/criteria may be used as well by a user device in determining whether or not to rejecting a scheduling grant received from the serving cell/serving BS.

According to an example implementation, the method of FIG. 3 may further include determining, by the user device based on the first control information received from the serving cell, a downlink/uplink (DL/UL) configuration of the serving cell for a time interval corresponding to the scheduling grant and determining, by the user device based on the second control information from one or more other cells, a downlink/uplink (DL/UL) configuration of each of the one or more other cells for the time interval corresponding to the scheduling grant. Also, for example, the determining whether or not to reject the scheduling grant may include determining whether or not to reject the scheduling grant from the serving cell based upon the downlink/uplink configuration of the serving cell and the downlink/uplink configuration of the one or more other cells. As noted, in an example implementation, each subframe may be allocated for uplink or downlink communication for the data portion of the subframe. According to an example implementation, a user device may reject a scheduling grant for a subframe (associated with a first time interval) if a non-serving cell is detected (e.g., based on second control information) that has a same DL/UL configuration for a subframe of a first time interval that is the same DL/UL configuration as the serving cell. For example, a user device may reject an uplink scheduling grant for a subframe (UL configuration for that subframe) received from a serving cell if a second control information indicates a neighbor/non-serving cell also has a UL configuration for a subframe of the same time interval. Alternatively, the user device may reject a scheduling grant if a neighbor cell has a DL/UL configuration for a subframe that is different than the serving cell for a subframe of the same time interval.

According to another example implementation of the method shown in FIG. 3, the method may further include determining, by the user device based on the first control information received from the serving cell, a downlink/uplink configuration of the serving cell, determining, by the user device based on at least the portion of the second control information received from one or more other cells, a downlink/uplink configuration of each of the one or more other cells, measuring a signal power or signal quality of a signal received from the serving cell, and measuring a signal power or signal quality of a signal received from each of the one or more other cells. In this example, the determining whether or not to reject the scheduling grant may include determining whether or not to reject the scheduling grant from the serving cell based upon the downlink/uplink configuration of the serving cell, the downlink/uplink configuration of the one or more other cells, the measured signal power or signal quality of a signal received from the serving cell, and the measured signal power or signal quality of a signal received from the one or more other cells.

Table 1 below describes example determination rules for a user device (or UE) to determine whether or not to reject a scheduling grant based on the DL/UL configuration of the serving cell, DL/UL configuration of the neighbor/non-serving cell, and signal power (e.g., RSRP) and/or signal quality (RSRQ) of signals received from the serving cell and/or neighbor/non-serving cell(s). These are merely some example illustrative rules, and other determination rules may be used.

TABLE 1

| Other cells DL/ | Serving cell DL/UL config. | |
|---|---|---|
| UL config. | DL | UL |
| DL | Reject SG if | Reject SG if |
| | RSRP/RSRQ of the | RSRP/RSRQ of the |
| | serving cell is lower than | serving cell is lower than |
| | certain threshold | certain threshold and |
| | | RSRP/RSRQ of the |
| | | other cells is larger than |
| | | certain threshold |
| UL | Reject SG if | Reject SG if |
| | RSRP/RSRQ of the | RSRP/RSRQ of the |
| | other cells is larger than | serving cell is lower than |
| | certain threshold | RSRP/RSRQ of the |
| | | other cells. |

According to another example implementation, the user device may determine whether or not to reject a scheduling grant based on a total amount of resources allocated for use/transmission in a subframe, and/or a total amount of high priority resources allocated for use/transmission in a subframe, for either the serving cell and/or one or more non-serving cells.

According to another example implementation of the method shown in FIG. 3, the method may further include determining, by the user device based on at least the portion of the second control information received from each of the one or more other cells, a total amount of resources scheduled for communications in each of the one or more other cells for a subframe or time interval. And, according to an example implementation, the determining whether or not to reject the scheduling grant may include determining whether or not to reject the scheduling grant from the serving cell based upon the total amount of resources (and/or the specific resources) scheduled for communications in each of the one or more other cells for the time interval.

According to another example implementation, the method of FIG. 3 may further include determining, by the user device based on at least the portion of the second control information received from each of the one or more other cells, a total amount of resources (and/or the specific resources) scheduled for communications in each of the one or more other cells for a time interval, and determining, by the user device, one or more high priority resources (or a total amount of high priority resources) allocated by each of the one or more other cells. And, the determining whether or not to reject the scheduling grant may include determining whether or not to reject the scheduling grant from the serving cell based upon the scheduling grant from the serving cell, the total amount of (and/or specific) resources scheduled for communications in each of the one or more other cells and the one or more high priority resources (and/or the total amount of high priority resources) allocated by each of the one or more other cells.

A brief illustrative example will now be described in which specific resources, total resources, and total or specific high priority resources that have been allocated or scheduled for use by serving and non-serving cells may be used by a user device to determine whether or not to reject a scheduling grant. In this illustrative example, there are three cells: cell 1, cell 2 and cell 3; and there are 9 PRBs shared among these three cells, PRBs 1-9. While each of the cells may use any of the nine PRBs, three different PRBs are assigned as high priority PRBs to each cell.

For example, the following PRBs may be assigned as high priority:

Cell 1—PRBs 1-3 are high priority

Cell 2—PRBs 4-6 are high priority; and

Cell 3—PRBs 7-9 are high priority.

In this illustrative example, cell 1 schedules several PRBs in one or more scheduling grants, including scheduling PRB 4 to user device 131. Thus, cell 1 is a serving cell for user device 131, while cells 2 and 3 are neighbor/non-serving cells to user device 131. In this example, user device 131 receives information indicating that PRBs 1-3 are high priority for serving cell 1, and that PRBs 4-6 are high priority for non-serving cell 2. An example rule, known by the user device 131, is that cells will first schedule or allocate their own high priority resources/PRBs, before scheduling other cells' high priority resources, within the pool of shared resources/shared PRBs 1-9. Thus, cell 2 will allocate or schedule its high priority resources PRBs 4-6 before scheduling or allocating other PRBs.

In this example, user device 131 may receive a scheduling grant in a subframe from serving cell 1 that allocates PRB 4 to user device 131. Also, user device 131 may receive a control information, e.g., TX control information, that includes a PRB/resource usage count field that indicates that 3 PRBs have been allocated or used for this subframe. And, user device 131 received information indicating that PRBs 4-6 are high priority for cell 2, and will be allocated first by cell 2 before the lower priority resources. Because, in this example, PRBs 4-6 are high priority for non-serving cell 2, user device 131 knows that PRB 4 has been allocated or scheduled for use within non-serving/neighbor cell 2. Or alternatively, the control information from the non-serving cell 2 may specifically identify that PRB 4 has been allocated or scheduled or is being used in the subframe. In this case, the user device 131 may reject the scheduling grant from serving cell 1 that allocates PRB 4 to user device 131, e.g., because of the use (e.g., conflict or overlap in use) of this same PRB 4 by cell 2, and because the allocation or use of PRB 4 by non-serving cell 2 is a higher priority than the use of PRB 4 by serving cell 1 (e.g., PRB 4 is a high priority resource only within/for cell 2), according to an illustrative example implementation.

According to another example implementation of the method shown in FIG. 3, the user device 131 may determine whether or not to reject a scheduling grant based on whether or not there is a conflict in use or overlap in specific resources/PRBs schedules or allocated for use at the same time in two or more different cells. Thus, in this example implementation, the user device may reject a scheduling grant based on a conflict in the scheduled or allocated resources among the serving cell and a non-serving cell. For example, a user device may reject a scheduling grant based on a scheduled use by a non-serving cell of the specific resource that was also allocated to (or scheduled for use by) the user device by the serving cell.

According to another example implementation of the method shown in FIG. 3, the specific allocation or scheduling of resources may be received. The method may further include determining, by the user device based on the portion of the second control information received from one or more other cells, one or more resources allocated for communication by one or more of the other cells, and determining if there is any overlap between the resource identified by the scheduling grant received from the serving cell and the one or more resources allocated by one or more of the other (non-serving/neighbor) cells. Also, the determining, by the user device, whether or not to reject the scheduling grant may include determining whether or not to reject the scheduling grant based, at least in part, on whether there is any overlap between the resource identified by the scheduling grant received from the serving cell and the one or more resources allocated by one or more of the other (non-serving/neighbor) cells.

According to another example implementation, the determining, by the user device, whether or not to reject the scheduling grant comprises determining whether or not to reject the scheduling grant based, at least in part, on whether there is any overlap between the resource identified by the scheduling grant received from the serving cell and the one or more resources allocated by one or more of the other cells, a priority of the scheduling grant from the serving cell, and a priority of the allocation of one or more resources by one or more of the other (non-serving/neighbor) cells.

According to another example implementation of the method shown in FIG. 3, the method may further include determining, by the user device based on the first control information received from the serving cell, that a first resource is allocated by the scheduling grant from the serving cell to the user device, determining a priority for the scheduling grant from the serving cell, determining, by the user device, that a non-serving cell that is not serving the user device, has also scheduled the first resource for communication within the non-serving cell, and determining a priority for the scheduling of the first resource by the non-serving cell. The determining whether or not to reject the scheduling grant may include: determining to reject the scheduling grant from the serving cell if a priority of the first resource scheduled by the non-serving cell for communication is a higher than the priority of the first resource allocated by the scheduling grant from the serving cell. In another example implementation, the determining whether or not to reject the scheduling grant may further include: determining to reject the scheduling grant from the serving cell if a priority of the first resource scheduled by the non-serving cell for communication is higher than or the same as the priority of the first resource allocated by the scheduling grant from the serving cell.

According to another example implementation of the method shown in FIG. 3, the determining whether or not to reject the scheduling grant may further include: determining not to reject the scheduling grant if a priority of the first resource scheduled by the non-serving cell for communication is a same or lower than the priority of the first resource allocated by the scheduling grant from the serving cell.

According to another example implementation of the method shown in FIG. 3, the method may further include determining, by the user device based on the first control portion received from the serving cell, that a first resource is allocated by the scheduling grant by the serving cell to the user device, determining, by the user device, that a non-serving cell that is not serving the user device, has also scheduled the first resource for communication within the non-serving cell, measuring a signal power or signal quality of a signal received from the serving cell, and measuring a signal power or signal quality of a signal received from the non-serving cell. Also, the determining whether or not to reject the scheduling grant may include determining whether or not to reject the scheduling grant from the serving cell based upon the measured signal power or signal quality of a signal received from the serving cell, and the measured signal power or signal quality of a signal received from the non-serving cell.

According to another example implementation of the method shown in FIG. 3, the control portion from the serving cell also may also indicate whether or not the scheduling grant may be rejected.

According to another example implementation of the method shown in FIG. 3, the method may further include rejecting the scheduling grant by the user device controlling sending a message rejecting the scheduling grant to the serving cell, the message rejecting the scheduling grant including a cause value that identifies the cause or reason why the user device is rejecting the grant.

As noted, there may be a need for user devices in neighboring or adjacent cells to coordinate in the usage of wireless resources, and/or to selectively accept or reject a resource grant. It may be desirable to prevent an interference situation where a user device in a first cell uses a resource for wireless communication that has also been allocated or granted in a second cell, where the second cell is a neighbor or adjacent cell to the first cell (or at least sufficiently close to cause interference between the two cells). Also, the situation should be avoided where both cells would reject a same resource grant, as that would waste the resource grant. The various options, alternatives and example implementations described herein for determining whether or not a user device should reject a scheduling grant may be used by each user device. In one example implementation, multiple (or all relevant) user devices would be configured with a common (or same) set of rules for determining whether the user device should accept or reject a scheduling/resource grant. As described herein, the relevant user devices may be configured with a set of rules for determining whether to accept or reject a scheduling grant based on priority, signal quality, signal strength or other criteria.

For example, an equal probability rule may be applied by a user device if a user device cannot the priority or decision on granted resources among neighboring cells including the serving cell. For instance, if the same resource is scheduled for UL transmission among three neighboring cells, then a user device in a current cell may determine to reject the UL grant with a probability of ⅓ (e.g., only ⅓ probability of successful transmission based on same resource being allocated to two other cells/user devices). Thus, in this example, based on the ⅓ probability, the user device may reject the scheduling grant.

Also, according to an example implementation, a grant rejection message may include a cause value that identifies the cause or reason why the user device is rejecting the grant, e.g., based on higher priority in cell X, based on higher signal power from cell X, or other cause/reason. In an example implementation, the cause value (identifying the reason for grant rejection) may be one of a plurality of predefined value, where each value identifies a specific reason for rejecting the grant, or identifies a specific reason type. In an example implementation, the cause value, identifying a reason or cause for rejection of a scheduling grant, may assist the BS or AN to make future resource scheduling decisions to avoid unnecessary grant rejections or grant/resource conflicts with neighboring cells.

According to another example implementation, an apparatus may include at least one processor and at least one memory including computer instructions, when executed by the at least one processor, cause the apparatus to: control receiving (310), by a user device from a serving cell, a first control information including a scheduling grant that identifies a resource to be used for communication between the user device and the serving cell; control receiving (320), by the user device, at least a part of a second control information from one or more other cells that are not serving the user device; and determine (330), by the user device, whether or not to reject the scheduling grant from the serving cell based on at least the first control information received from the serving cell and the part of the second control information received from the one or more other cells that are not serving the user device.

According to an example implementation, wherein causing the apparatus to determine may include causing the apparatus to determine to reject the scheduling grant based on a conflict or overlap between the resource identified by the scheduling grant from the serving cell and a resource identified in the second control information from one or more of the other cells that are not serving the user device.

According to an example implementation, the scheduling grant identifies an uplink resource to be used for the user device to communicate with the serving cell; wherein causing the apparatus to determine comprises causing the apparatus to determine to reject the scheduling grant; wherein the apparatus being further configured to reject the uplink scheduling grant by the user device not transmitting data to the serving cell via the uplink resource identified by the scheduling grant.

According to an example implementation, the scheduling grant identifies an uplink resource to be used for the user device to communicate with the serving cell; wherein the apparatus being configured to determine comprises the apparatus being configured to determine to reject the scheduling grant; wherein the apparatus is further configured to reject the uplink scheduling grant by the user device controlling sending a scheduling grant request or a buffer status report indicating data for transmission to the serving cell.

According to an example implementation, the scheduling grant identifies a downlink resource to be used for the user device to receive data from the serving cell; wherein the apparatus being configured to determine includes the apparatus being configured to determine to reject the scheduling grant; wherein the apparatus is further configured to reject the scheduling grant by the user device controlling sending a message rejecting the scheduling grant to the serving cell.

According to an example implementation, the apparatus being configured to determine may include the apparatus being configured to determine, by the user device, not to reject the scheduling grant from the serving cell; and the apparatus being further configured to use, by the user device, the resource identified by the scheduling grant to communicate with the serving cell.

According to an example implementation, the apparatus is further configured to: determine, by the user device based on the first control information received from the serving cell, a downlink/uplink configuration of the serving cell for a time interval corresponding to the scheduling grant; determine, by the user device based on the second control information from one or more other cells, a downlink/uplink configuration of each of the one or more other cells for the time interval corresponding to the scheduling grant; and wherein the apparatus being configured to determine whether or not to reject the scheduling grant includes being configured to determine whether or not to reject the scheduling grant from the serving cell based upon the downlink/uplink configuration of the serving cell and the downlink/uplink configuration of the one or more other cells.

According to an example implementation, the apparatus is further configured to: measure a signal power or signal quality of a signal received from each of the one or more other cells; wherein the apparatus being configured to determine whether or not to reject the scheduling grant includes the apparatus being configured to determine whether or not to reject the scheduling grant from the serving cell based upon the downlink/uplink configuration of the serving cell, the downlink/uplink configuration of the one or more other cells, and the measured signal power or signal quality of a signal received from the one or more other cells.

According to an example implementation, the apparatus is further configured to: determine, by the user device based on the first control information received from the serving cell, a downlink/uplink configuration of the serving cell; determine, by the user device based on at least the portion of the second control information received from one or more other cells, a downlink/uplink configuration of each of the one or more other cells; measure a signal power or signal quality of a signal received from the serving cell; measure a signal power or signal quality of a signal received from each of the one or more other cells; wherein the apparatus being configured to determine whether or not to reject the scheduling grant includes the apparatus being configured to determine whether or not to reject the scheduling grant from the serving cell based upon the downlink/uplink configuration of the serving cell, the downlink/uplink configuration of the one or more other cells, the measured signal power or signal quality of a signal received from the serving cell, and the measured signal power or signal quality of a signal received from the one or more other cells.

According to an example implementation, the apparatus is further configured to: determine, by the user device based on at least the portion of the second control information received from each of the one or more other cells, a total amount of resources scheduled for communications in each of the one or more other cells for a time interval; wherein the apparatus being configured to determine whether or not to reject the scheduling grant includes the apparatus being configured to determine whether or not to reject the scheduling grant from the serving cell based upon the total amount of resources scheduled for communications in each of the one or more other cells for the time interval.

According to an example implementation, the apparatus is further configured to: determine, by the user device based on at least the portion of the second control information received from each of the one or more other cells, one or more resources scheduled for communications in each of the one or more other cells for a time interval; wherein the apparatus being configured to determine whether or not to reject the scheduling grant includes the apparatus being configured to determine whether or not to reject the scheduling grant from the serving cell based upon the one or more resources scheduled for communications in each of the one or more other cells for the time interval.

According to an example implementation, wherein the apparatus is further configured to: determine, by the user device based on at least the portion of the second control information received from each of the one or more other cells, a total amount of resources scheduled for communications in each of the one or more other cells for a time interval; determine, by the user device, one or more high priority resources allocated by each of the one or more other cells; wherein the apparatus being configured to determine whether or not to reject the scheduling grant includes the apparatus being configured to determine whether or not to reject the scheduling grant from the serving cell based upon the scheduling grant from the serving cell, the total amount of resources scheduled for communications in each of the one or more other cells and the one or more high priority resources allocated by each of the one or more other cells.

According to an example implementation, the apparatus is further configured to: determine, by the user device based on the portion of the second control information received from one or more other cells, one or more resources allocated for communication by one or more of the other cells; determine if there is any overlap between the resource identified by the scheduling grant received from the serving cell and the one or more resources allocated by one or more of the other cells; wherein the apparatus being configured to determine, by the user device, whether or not to reject the scheduling grant includes determining whether or not to reject the scheduling grant based, at least in part, on whether there is any overlap between the resource identified by the scheduling grant received from the serving cell and the one or more resources allocated by one or more of the other cells.

According to an example implementation, the apparatus being configured to determine, by the user device, whether or not to reject the scheduling grant includes the apparatus being configured to determine whether or not to reject the scheduling grant based, at least in part, on whether there is any overlap between the resource identified by the scheduling grant received from the serving cell and the one or more resources allocated by one or more of the other cells, a priority of the scheduling grant from the serving cell, and a priority of the allocation of one or more resources by one or more of the other cells.

According to an example implementation, the apparatus is further configured to: determine, by the user device based on the first control information received from the serving cell, that a first resource is allocated by the scheduling grant from the serving cell to the user device; determine a priority for the scheduling grant from the serving cell; determine, by the user device, that a non-serving cell that is not serving the user device, has also scheduled the first resource for communication within the non-serving cell; determine a priority for the scheduling of the first resource by the non-serving cell; wherein the apparatus being configured to determine whether or not to reject the scheduling grant includes the apparatus being configured to: determine to reject the scheduling grant from the serving cell if a priority of the first resource scheduled by the non-serving cell for communication is higher than the priority of the first resource allocated by the scheduling grant from the serving cell.

According to an example implementation, the apparatus being configured to determine whether or not to reject the scheduling grant further comprises the apparatus being configured to: determine to reject the scheduling grant from the serving cell if a priority of the first resource scheduled by the non-serving cell for communication is higher than or the same as the priority of the first resource allocated by the scheduling grant from the serving cell.

According to an example implementation, the apparatus being configured to determine whether or not to reject the scheduling grant further includes the apparatus being configured to: determine not to reject the scheduling grant if a priority of the first resource scheduled by the non-serving cell for communication is a same or lower than the priority of the first resource allocated by the scheduling grant from the serving cell.

According to an example implementation, the apparatus is further configured to: determine, by the user device based on the first control portion received from the serving cell, that a first resource is allocated by the scheduling grant by the serving cell to the user device; determine, by the user device, that a non-serving cell that is not serving the user device, has also scheduled the first resource for communication within the non-serving cell; measure a signal power or signal quality of a signal received from the serving cell; measure a signal power or signal quality of a signal received from the non-serving cell; wherein the apparatus being configured to determine whether or not to reject the scheduling grant includes being configured to determine whether or not to reject the scheduling grant from the serving cell based upon the measured signal power or signal quality of a signal received from the serving cell, and the measured signal power or signal quality of a signal received from the non-serving cell.

According to an example implementation, a computer program product includes a computer-readable storage medium and storing executable code that, when executed by at least one data processing apparatus, is configured to cause the at least one data processing apparatus to perform a method comprising: controlling receiving (310), by a user device from a serving cell, a first control information including a scheduling grant that identifies a resource to be used for communication between the user device and the serving cell; controlling receiving (320), by the user device, at least a part of a second control information from one or more other cells that are not serving the user device; and determining (330), by the user device, whether or not to reject the scheduling grant from the serving cell based on at least the first control information received from the serving cell and the part of the second control information received from the one or more other cells that are not serving the user device.

According to an example implementation of the computer program product, the determining includes determining to reject the scheduling grant based on a conflict or overlap between the resource identified by the scheduling grant from the serving cell and a resource identified in the second control information from one or more of the other cells that are not serving the user device.

According to an example implementation of the computer program product, the scheduling grant identifies an uplink resource to be used for the user device to communicate with the serving cell; wherein the determining includes determining to reject the scheduling grant; wherein the method further includes rejecting the uplink scheduling grant by the user device not transmitting data to the serving cell via the uplink resource identified by the scheduling grant.

According to an example implementation of the computer program product, the scheduling grant identifies an uplink resource to be used for the user device to communicate with the serving cell; wherein the determining includes determining to reject the scheduling grant; wherein the method further includes rejecting the uplink scheduling grant by the user device controlling sending a scheduling grant request or a buffer status report indicating data for transmission to the serving cell.

According to an example implementation of the computer program product, the scheduling grant identifies a downlink resource to be used for the user device to receive data from the serving cell; wherein the determining includes determining to reject the scheduling grant; wherein the method further includes rejecting the scheduling grant by the user device controlling sending a message rejecting the scheduling grant to the serving cell.

According to an example implementation of the computer program product, the determining includes determining, by the user device, not to reject the scheduling grant from the serving cell; and the method further includes using, by the user device, the resource identified by the scheduling grant to communicate with the serving cell.

According to an example implementation of the computer program product, the method further including: determining, by the user device based on the first control information received from the serving cell, a downlink/uplink configuration of the serving cell for a time interval corresponding to the scheduling grant; determining, by the user device based on the second control information from one or more other cells, a downlink/uplink configuration of each of the one or more other cells for the time interval corresponding to the scheduling grant; and wherein the determining whether or not to reject the scheduling grant includes determining whether or not to reject the scheduling grant from the serving cell based upon the downlink/uplink configuration of the serving cell and the downlink/uplink configuration of the one or more other cells.

According to an example implementation of the computer program product, the method further including: measuring a signal power or signal quality of a signal received from each of the one or more other cells; wherein the determining whether or not to reject the scheduling grant includes determining whether or not to reject the scheduling grant from the serving cell based upon the downlink/uplink configuration of the serving cell, the downlink/uplink configuration of the one or more other cells, and the measured signal power or signal quality of a signal received from the one or more other cells.

According to an example implementation of the computer program product, the method further including: determining, by the user device based on the first control information received from the serving cell, a downlink/uplink configuration of the serving cell; determining, by the user device based on at least the portion of the second control information received from one or more other cells, a downlink/uplink configuration of each of the one or more other cells; measuring a signal power or signal quality of a signal received from the serving cell; measuring a signal power or signal quality of a signal received from each of the one or more other cells; wherein the determining whether or not to reject the scheduling grant includes determining whether or not to reject the scheduling grant from the serving cell based upon the downlink/uplink configuration of the serving cell, the downlink/uplink configuration of the one or more other cells, the measured signal power or signal quality of a signal received from the serving cell, and the measured signal power or signal quality of a signal received from the one or more other cells.

According to an example implementation of the computer program product, the method further including: determining, by the user device based on at least the portion of the second control information received from each of the one or more other cells, a total amount of resources scheduled for communications in each of the one or more other cells for a time interval; wherein the determining whether or not to reject the scheduling grant includes determining whether or not to reject the scheduling grant from the serving cell based upon the total amount of resources scheduled for communications in each of the one or more other cells for the time interval.

According to an example implementation of the computer program product, the method further including: determining, by the user device based on at least the portion of the second control information received from each of the one or more other cells, one or more resources scheduled for communications in each of the one or more other cells for a time interval; wherein the determining whether or not to reject the scheduling grant includes determining whether or not to reject the scheduling grant from the serving cell based upon the one or more resources scheduled for communications in each of the one or more other cells for the time interval.

According to an example implementation of the computer program product, the method further including: determining, by the user device based on at least the portion of the second control information received from each of the one or more other cells, a total amount of resources scheduled for communications in each of the one or more other cells for a time interval; determining, by the user device, one or more high priority resources allocated by each of the one or more other cells; wherein the determining whether or not to reject the scheduling grant includes determining whether or not to reject the scheduling grant from the serving cell based upon the scheduling grant from the serving cell, the total amount of resources scheduled for communications in each of the one or more other cells and the one or more high priority resources allocated by each of the one or more other cells.

According to an example implementation of the computer program product, the method further including: determining, by the user device based on the portion of the second control information received from one or more other cells, one or more resources allocated for communication by one or more of the other cells; determining if there is any overlap between the resource identified by the scheduling grant received from the serving cell and the one or more resources allocated by one or more of the other cells; wherein the determining, by the user device, whether or not to reject the scheduling grant comprises determining whether or not to reject the scheduling grant based, at least in part, on whether there is any overlap between the resource identified by the scheduling grant received from the serving cell and the one or more resources allocated by one or more of the other cells.

According to an example implementation of the computer program product, wherein the determining, by the user device, whether or not to reject the scheduling grant includes determining whether or not to reject the scheduling grant based, at least in part, on whether there is any overlap between the resource identified by the scheduling grant received from the serving cell and the one or more resources allocated by one or more of the other cells, a priority of the scheduling grant from the serving cell, and a priority of the allocation of one or more resources by one or more of the other cells.

According to an example implementation of the computer program product, the method further including: determining, by the user device based on the first control information received from the serving cell, that a first resource is allocated by the scheduling grant from the serving cell to the user device; determining a priority for the scheduling grant from the serving cell; determining, by the user device, that a non-serving cell that is not serving the user device, has also scheduled the first resource for communication within the non-serving cell; determining a priority for the scheduling of the first resource by the non-serving cell; wherein the determining whether or not to reject the scheduling grant includes: determining to reject the scheduling grant from the serving cell if a priority of the first resource scheduled by the non-serving cell for communication is higher than the priority of the first resource allocated by the scheduling grant from the serving cell.

According to an example implementation of the computer program product, the determining whether or not to reject the scheduling grant further includes: determining to reject the scheduling grant from the serving cell if a priority of the first resource scheduled by the non-serving cell for communication is higher than or the same as the priority of the first resource allocated by the scheduling grant from the serving cell.

According to an example implementation of the computer program product, the determining whether or not to reject the scheduling grant further includes: determining not to reject the scheduling grant if a priority of the first resource scheduled by the non-serving cell for communication is a same or lower than the priority of the first resource allocated by the scheduling grant from the serving cell.

According to an example implementation of the computer program product, the method further including: determining, by the user device based on the first control portion received from the serving cell, that a first resource is allocated by the scheduling grant by the serving cell to the user device; determining, by the user device, that a non-serving cell that is not serving the user device, has also scheduled the first resource for communication within the non-serving cell; measuring a signal power or signal quality of a signal received from the serving cell; measuring a signal power or signal quality of a signal received from the non-serving cell; wherein the determining whether or not to reject the scheduling grant includes determining whether or not to reject the scheduling grant from the serving cell based upon the measured signal power or signal quality of a signal received from the serving cell, and the measured signal power or signal quality of a signal received from the non-serving cell.

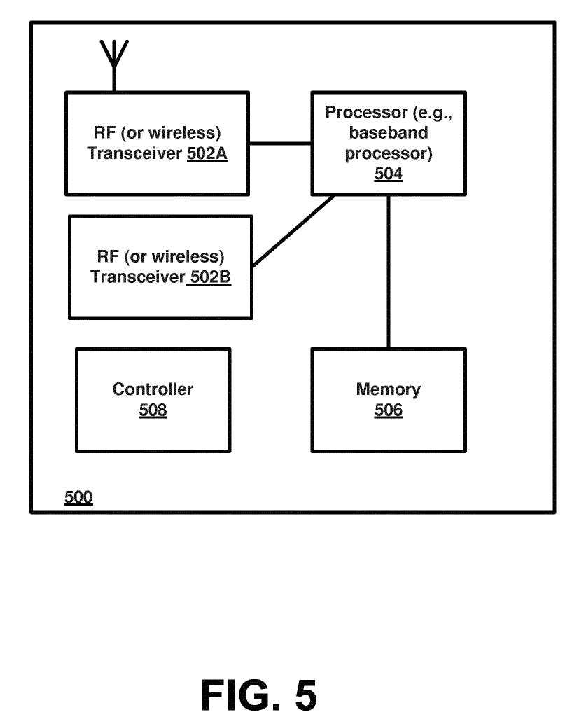

According to another example implementation, with reference to FIGS. 3, 5) an apparatus (500) may include: means (502A/502B, 504, 310) for controlling receiving, by a user device from a serving cell, a first control information including a scheduling grant that identifies a resource to be used for communication between the user device and the serving cell; means (502A/502B, 504, 320) for controlling receiving, by the user device, at least a part of a second control information from one or more other cells that are not serving the user device; and means (502A/502B, 504, 330) for determining, by the user device, whether or not to reject the scheduling grant from the serving cell based on at least the first control information received from the serving cell and the part of the second control information received from the one or more other cells that are not serving the user device.

According to an example implementation, the means for determining may include means (502A/502B, 504) for determining to reject the scheduling grant based on a conflict or overlap between the resource identified by the scheduling grant from the serving cell and a resource identified in the second control information from one or more of the other cells that are not serving the user device.

According to an example implementation, the scheduling grant identifies an uplink resource to be used for the user device to communicate with the serving cell; wherein the means for determining may include means (502A/502B, 504) for determining to reject the scheduling grant; wherein the apparatus further includes means for rejecting the uplink scheduling grant by the user device not transmitting data to the serving cell via the uplink resource identified by the scheduling grant.

According to an example implementation, the scheduling grant identifies an uplink resource to be used for the user device to communicate with the serving cell; wherein the means for determining may include means (502A/502B, 504) for determining to reject the scheduling grant; wherein the apparatus further includes means (502A/502B, 504) for rejecting the uplink scheduling grant by the user device controlling sending a scheduling grant request or a buffer status report indicating data for transmission to the serving cell.

According to an example implementation, the scheduling grant identifies a downlink resource to be used for the user device to receive data from the serving cell; wherein the means for determining may include means (502A/502B, 504) for determining to reject the scheduling grant; wherein the apparatus further includes means (502A/502B, 504) for rejecting the scheduling grant by the user device controlling sending a message rejecting the scheduling grant to the serving cell.

According to an example implementation, the means for determining may include means (502A/502B, 504) for determining, by the user device, not to reject the scheduling grant from the serving cell; and the apparatus further including means (502A/502B, 504) for using, by the user device, the resource identified by the scheduling grant to communicate with the serving cell.

According to an example implementation, the apparatus further including: means (502A/502B, 504) for determining, by the user device based on the first control information received from the serving cell, a downlink/uplink configuration of the serving cell for a time interval corresponding to the scheduling grant; means (502A/502B, 504) for determining, by the user device based on the second control information from one or more other cells, a downlink/uplink configuration of each of the one or more other cells for the time interval corresponding to the scheduling grant; and wherein the means for determining whether or not to reject the scheduling grant includes means (502A/502B, 504) for determining whether or not to reject the scheduling grant from the serving cell based upon the downlink/uplink configuration of the serving cell and the downlink/uplink configuration of the one or more other cells.

According to an example implementation, the apparatus further including: means (502A/502B, 504) for measuring a signal power or signal quality of a signal received from each of the one or more other cells; wherein the means for determining whether or not to reject the scheduling grant includes means (502A/502B, 504) for determining whether or not to reject the scheduling grant from the serving cell based upon the downlink/uplink configuration of the serving cell, the downlink/uplink configuration of the one or more other cells, and the measured signal power or signal quality of a signal received from the one or more other cells.

According to an example implementation, the apparatus further including means (502A/502B, 504) for determining, by the user device based on the first control information received from the serving cell, a downlink/uplink configuration of the serving cell; means (502A/502B, 504) for determining, by the user device based on at least the portion of the second control information received from one or more other cells, a downlink/uplink configuration of each of the one or more other cells; means f(502A/502B, 504) or measuring a signal power or signal quality of a signal received from the serving cell; means (502A/502B, 504) for measuring a signal power or signal quality of a signal received from each of the one or more other cells; wherein the means for determining whether or not to reject the scheduling grant includes means (502A/502B, 504) for determining whether or not to reject the scheduling grant from the serving cell based upon the downlink/uplink configuration of the serving cell, the downlink/uplink configuration of the one or more other cells, the measured signal power or signal quality of a signal received from the serving cell, and the measured signal power or signal quality of a signal received from the one or more other cells.

According to an example implementation, the apparatus further includes: means (502A/502B, 504) for determining, by the user device based on at least the portion of the second control information received from each of the one or more other cells, a total amount of resources scheduled for communications in each of the one or more other cells for a time interval; wherein the means for determining whether or not to reject the scheduling grant includes means (502A/502B, 504) for determining whether or not to reject the scheduling grant from the serving cell based upon the total amount of resources scheduled for communications in each of the one or more other cells for the time interval.

According to an example implementation, the apparatus further includes: means (502A/502B, 504) for determining, by the user device based on at least the portion of the second control information received from each of the one or more other cells, one or more resources scheduled for communications in each of the one or more other cells for a time interval; wherein the means for determining whether or not to reject the scheduling grant includes means (502A/502B, 504) for determining whether or not to reject the scheduling grant from the serving cell based upon the one or more resources scheduled for communications in each of the one or more other cells for the time interval.

According to an example implementation, the apparatus further includes means (502A/502B, 504) for determining, by the user device based on at least the portion of the second control information received from each of the one or more other cells, a total amount of resources scheduled for communications in each of the one or more other cells for a time interval; means (502A/502B, 504) for determining, by the user device, one or more high priority resources allocated by each of the one or more other cells; wherein the means for determining whether or not to reject the scheduling grant includes means for determining whether or not to reject the scheduling grant from the serving cell based upon the scheduling grant from the serving cell, the total amount of resources scheduled for communications in each of the one or more other cells and the one or more high priority resources allocated by each of the one or more other cells.

According to an example implementation, the apparatus further including: means (502A/502B, 504) for determining, by the user device based on the portion of the second control information received from one or more other cells, one or more resources allocated for communication by one or more of the other cells; means (502A/502B, 504) for determining if there is any overlap between the resource identified by the scheduling grant received from the serving cell and the one or more resources allocated by one or more of the other cells; wherein the means for determining, by the user device, whether or not to reject the scheduling grant may include means for determining whether or not to reject the scheduling grant based, at least in part, on whether there is any overlap between the resource identified by the scheduling grant received from the serving cell and the one or more resources allocated by one or more of the other cells.

According to an example implementation of the apparatus, the means for determining, by the user device, whether or not to reject the scheduling grant may include means (502A/502B, 504) for determining whether or not to reject the scheduling grant based, at least in part, on whether there is any overlap between the resource identified by the scheduling grant received from the serving cell and the one or more resources allocated by one or more of the other cells, a priority of the scheduling grant from the serving cell, and a priority of the allocation of one or more resources by one or more of the other cells.

According to an example implementation, the apparatus may further include means (502A/502B, 504) for determining, by the user device based on the first control information received from the serving cell, that a first resource is allocated by the scheduling grant from the serving cell to the user device; means (502A/502B, 504) for determining a priority for the scheduling grant from the serving cell; means (502A/502B, 504) for determining, by the user device, that a non-serving cell that is not serving the user device, has also scheduled the first resource for communication within the non-serving cell; means (502A/502B, 504) for determining a priority for the scheduling of the first resource by the non-serving cell; wherein the means for determining whether or not to reject the scheduling grant includes: means (502A/502B, 504) for determining to reject the scheduling grant from the serving cell if a priority of the first resource scheduled by the non-serving cell for communication is higher than the priority of the first resource allocated by the scheduling grant from the serving cell.

According to an example implementation, the means for determining whether or not to reject the scheduling grant further includes: means (502A/502B, 504) for determining to reject the scheduling grant from the serving cell if a priority of the first resource scheduled by the non-serving cell for communication is higher than or the same as the priority of the first resource allocated by the scheduling grant from the serving cell.

According to an example implementation, the means for determining whether or not to reject the scheduling grant further includes: means (502A/502B, 504) for determining not to reject the scheduling grant if a priority of the first resource scheduled by the non-serving cell for communication is a same or lower than the priority of the first resource allocated by the scheduling grant from the serving cell.

According to an example implementation, the apparatus further includes means (502A/502B, 504) for determining, by the user device based on the first control portion received from the serving cell, that a first resource is allocated by the scheduling grant by the serving cell to the user device; means (502A/502B, 504) for determining, by the user device, that a non-serving cell that is not serving the user device, has also scheduled the first resource for communication within the non-serving cell; means (502A/502B, 504) for measuring a signal power or signal quality of a signal received from the serving cell; means (502A/502B, 504) for measuring a signal power or signal quality of a signal received from the non-serving cell; wherein the means for determining whether or not to reject the scheduling grant includes means for determining whether or not to reject the scheduling grant from the serving cell based upon the measured signal power or signal quality of a signal received from the serving cell, and the measured signal power or signal quality of a signal received from the non-serving cell.

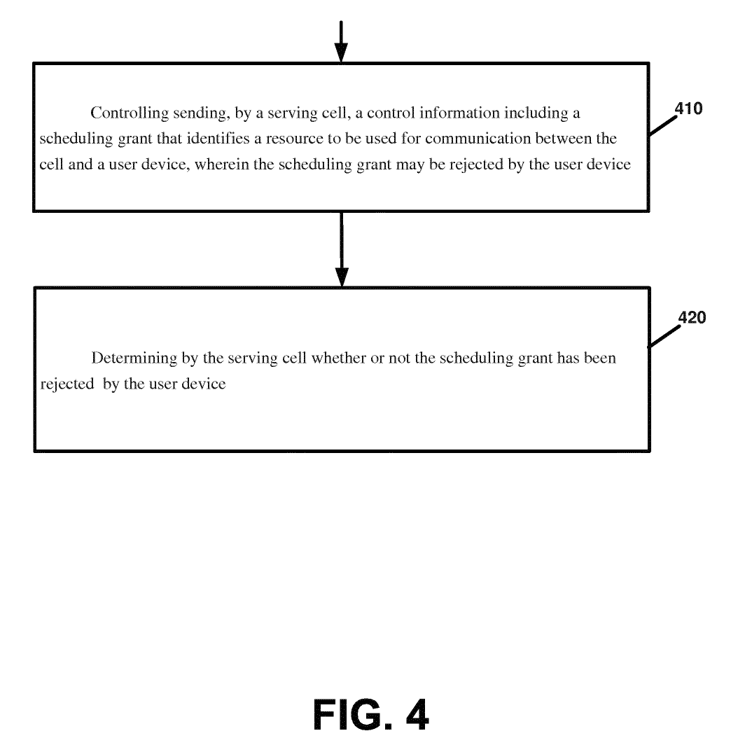

FIG. 4 is a flow chart illustrating operation of a serving cell or serving base station according to an example implementation. Operation 410 may include controlling sending, by a serving cell, a control information including a scheduling grant that identifies a resource to be used for communication between the cell and a user device, wherein the scheduling grant may be rejected by the user device. Operation 420 may include determining by the serving cell whether or not the scheduling grant has been rejected by the user device.

According to an example implementation of the method of FIG. 4, the control information may include a first control information including a first scheduling grant that identifies a first downlink resource. The method of FIG. 4 may further include: controlling receiving, by the serving cell from the user device, a message rejecting the first scheduling grant, and controlling sending by the serving cell, a second control information including a second scheduling grant that identifies a second downlink resource to be used for downlink communication between the serving cell and the user device based on the user device rejecting the first scheduling grant.

According to an example implementation of the method of FIG. 4, the scheduling grant may include a first scheduling grant that identifies a first uplink resource. And, the determining may include determining that the user device has rejected the first scheduling grant based on one or more of the following: determining, by the serving cell, that the user device did not use the first uplink resource to transmit data to the serving cell; and controlling receiving, by the serving cell from the user device, an explicit scheduling grant rejection that rejects the first scheduling grant. The explicit scheduling grant rejection may include at least one of the following: a scheduling request received by the serving cell from the user device that requests a resource; and a buffer status report received from the user device that indicates data for transmission to the serving cell.

According to an example implementation of the method of FIG. 4, the control information may include a first control information including a first scheduling grant that identifies a first downlink resource. The method of FIG. 4 may further include: receiving, by the serving cell from the user device, a message rejecting the first scheduling grant; and controlling sending by the serving cell, a second control information including a second scheduling grant that identifies a second downlink resource to be used for downlink communication between the serving cell and the user device based on the user device rejecting the first scheduling grant. Thus, the serving cell may send an additional (or subsequent or second) resource grant to a user device in response to receiving a message from the user device rejecting the first (or original) resource grant to the user device.

As noted above, in an example implementation, the message rejecting the first scheduling grant may include a cause value that may identify a cause or reason for rejecting a scheduling grant or allocated resource.

According to an example implementation of the method of FIG. 4, the control information may include a first control information including a first scheduling grant that identifies a first resource, and the user device includes a first user device. The determining may include determining that the first user device has rejected the first scheduling grant. And, the method of FIG. 4 may further include increasing, by the serving cell, a priority of the first user device to receive scheduling grants, as compared to a priority of other user devices served by the serving cell; and controlling sending, by the serving cell, a second control information including a second scheduling grant that identifies a second resource to be used for communication between the serving cell and the first user device.

Therefore, according to an example implementation, a user device or UE monitors the radio resource configuration of one or more (or even all) of the detected local cells/base stations or access nodes (ANs) and may reject the scheduling grant that the serving cell allocates to the individual user device/UE if a conflict on radio resource configuration (e.g., match of DL/UL configuration) among the detected local cells/BSs is identified or determined.

According to an example implementation, the user device/UE, regardless of the serving cell, may receive at least part of DL control information (also known as TX control information 240, FIG. 2) of one (or more or even all) the detected local cells/BSs/ANs so that the user device/UE may know the designated radio resource configuration (DL/UL configuration) of the other local cells or BSs or ANs (e.g., for a particular subframe or transmission time interval) and determine whether that may potentially interfere with the user device/UE transmission/reception in the serving cell.

In one alternative, the user device may only need to receive the control information on the dynamic DL or UL configuration of the data part in the detected local ANs/cells. To achieve this, the dynamic DL/UL configuration information may be indicated by reference sequence (e.g., a first group of reference sequences may be used to indicate TDD DL configured subframe for data part and a second (different) group of reference sequences may be used to indicate TDD UL configured subframe) or by the self-decoded common control part of Tx control 240. The user device/UE, based on DL/UL configuration of the other detected cells (neighbor/non-serving cells) and the serving cell and the received power from each cell, may determine to accept or reject the scheduling grant (SG) received from serving cell/BS/AN. For instance, the determination rules shown in Table 1 above may be used by the user device/UE to reject or accept SG.

As another alternative, in addition to the DL/UL configuration of each cell, a user device/UE can also receive, via the control information 240, the total amount of resources (e.g., resource/PRB resource usage count) that are scheduled in each detected local cell. In this alternative, each local cell/BS/AN may be pre-configured with the part of the shared spectrum to be used with high priority. If a user device/UE detects that the amount of resources scheduled by other (neighbor/non-serving) detected cells/BSs/ANs are larger than a certain threshold (e.g. the threshold may be defined as difference of total amount of resource blocks in shared spectrum and the amount of resource blocks with high priority in the cell) and the UE is scheduled out of the resource blocks with high priority (e.g., the user device/UE is scheduled into low priority resources, which may be high priority resources for another cell/BS), the user device/UE may determine to reject the scheduling grant.

As another alternative, the user device/UE can receive the full control information (e.g., TX control information) of the detected local cells/BSs/ANs so that the user device/UE knows or can determine the detailed scheduling information of each cell (e.g., which specific resources/PRBs have been allocated or scheduled for use by each local cell/BS/AN). For instance, a bitmap identifying the scheduled resources/PRBs may be announced by each cell/BS/AN in the self-decoded common control of Tx control part 240 of each subframe. Based on its own allocated resource(s) in the serving cell and also the scheduled resources in the other (neighbor or non-serving) cell(s), the user device/UE may determine to reject the scheduling grant or not. To facilitate the user device/UE to make the SG accept/reject decision, scheduling priority may be indicated in the scheduling grant so that the user device/UE may reject the scheduling grant only if same resource blocks are scheduled by other cells with higher scheduling priority, according to an example implementation. In addition, the rules defined in Table 1, as an illustrative example, can also be used by the user device/UE to determine if the scheduling grant should be rejected or not when a same resource are scheduled by multiple cells.

For all (or one or more) of the alternatives, cells/BSs/ANs may indicate in the Tx control part 240 if the DL scheduling grant can be rejected or not. The indication may be common to all the UEs in the cell with common control information element in Tx control 240 or specific to individual user device/UE in dedicated DL scheduling grant information. For the UL scheduling grant, UE may determine if the scheduling grant can be rejected or not, e.g., based on the user device/UE and/or service and/or bearer priority and other QoS (quality of service) requirements.

According to an example implementation, the user device/UE, upon determining to reject the scheduling grant, may indicate the rejection of scheduling grant in Rx control part 250. It can be an explicit rejection indication defined for Rx control part 250. Or it may be implicit indicated by sending a scheduling request (SR) in Rx control 250 on the same TTI (transmission time interval, for a frame or subframe) that the user device/UE receives the scheduling grant. As the Rx control part 250 may use contention based transmission, to achieve high reliability for user device/UE transmission of scheduling grant rejection indication, a user device/UE may be allocated with dedicated Rx control transmission resource if there is the scheduling grant in Tx control 240 for the user device/UE. The dedicated resource allocation for Rx control transmission may be explicitly indicated together with the scheduling grant. Or the dedicated resource for Rx control transmission may be implicitly indicated according to the allocated resource for data part. As the result, the data part of the current short frame or current subframe will be muted for the rejecting individual user device/UE.

According to an example implementation, an apparatus may include at least one processor and at least one memory including computer instructions, when executed by the at least one processor, cause the apparatus to: control sending (410), by a serving cell, a control information including a scheduling grant that identifies a resource to be used for communication between the cell and a user device, wherein the scheduling grant may be rejected by the user device; and determine (420) by the serving cell whether or not the scheduling grant has been rejected by the user device.

According to an example implementation of the apparatus, the control information may include a first control information including a first scheduling grant that identifies a first downlink resource, the wherein causing the apparatus to determine comprises causing the apparatus to further perform: control receiving, by the serving cell from the user device, a message rejecting the first scheduling grant; and control sending by the serving cell, a second control information including a second scheduling grant that identifies a second downlink resource to be used for downlink communication between the serving cell and the user device based on the user device rejecting the first scheduling grant.

According to an example implementation of the apparatus, the scheduling grant may include a first scheduling grant that identifies a first uplink resource; wherein causing the apparatus to determine may include causing the apparatus to determine that the user device has rejected the first scheduling grant based on one or more of the following: causing the apparatus to determine, by the serving cell, that the user device did not use the first uplink resource to transmit data to the serving cell; and causing the apparatus to control receiving, by the serving cell from the user device, an explicit scheduling grant rejection that rejects the first scheduling grant.

According to an example implementation of the apparatus, the explicit scheduling grant rejection comprises at least one of the following: a scheduling request received by the serving cell from the user device that requests a resource; and a buffer status report received from the user device that indicates data for transmission to the serving cell.

According to an example implementation of the apparatus, the control information may include a first control information including a first scheduling grant that identifies a first downlink resource, the apparatus further comprising causing the apparatus to: receive, by the serving cell from the user device, a message rejecting the first scheduling grant; and control sending by the serving cell, a second control information including a second scheduling grant that identifies a second downlink resource to be used for downlink communication between the serving cell and the user device based on the user device rejecting the first scheduling grant.

According to an example implementation of the apparatus, the control information may include a first control information including a first scheduling grant that identifies a first resource, and the user device comprises a first user device; wherein causing the apparatus to determine may include causing the apparatus to determine that the first user device has rejected the first scheduling grant; wherein the apparatus further includes causing the apparatus to: increase, by the serving cell, a priority of the first user device to receive scheduling grants, as compared to a priority of other user devices served by the serving cell; and control sending, by the serving cell, a second control information including a second scheduling grant that identifies a second resource to be used for communication between the serving cell and the first user device.

According to an example implementation of the apparatus, the apparatus may further include causing the apparatus to indicate, by the serving cell to the user device, that the scheduling grant can be rejected.

According to an example implementation of the apparatus, causing the apparatus to indicate comprises cause the apparatus to perform at least one of: control sending, by the serving cell to the user device, a message via common signaling indicating that the scheduling grant can be rejected; and control sending, by the serving cell to the user device, a message via dedicated signaling indicating that the scheduling grant can be rejected.

According to an example implementation, a computer program product includes a computer-readable storage medium and storing executable code that, when executed by at least one data processing apparatus, is configured to cause the at least one data processing apparatus to perform a method comprising: controlling sending (410), by a serving cell, a control information including a scheduling grant that identifies a resource to be used for communication between the cell and a user device, wherein the scheduling grant may be rejected by the user device; and determining (420) by the serving cell whether or not the scheduling grant has been rejected by the user device.

According to an example implementation of the computer program product, the control information may include a first control information including a first scheduling grant that identifies a first downlink resource, the method further comprising: controlling receiving, by the serving cell from the user device, a message rejecting the first scheduling grant; and controlling sending by the serving cell, a second control information including a second scheduling grant that identifies a second downlink resource to be used for downlink communication between the serving cell and the user device based on the user device rejecting the first scheduling grant.

According to an example implementation of the computer program product, the scheduling grant may include a first scheduling grant that identifies a first uplink resource; wherein the determining may include determining that the user device has rejected the first scheduling grant based on one or more of the following: determining, by the serving cell, that the user device did not use the first uplink resource to transmit data to the serving cell; and controlling receiving, by the serving cell from the user device, an explicit scheduling grant rejection that rejects the first scheduling grant.

According to an example implementation of the computer program product, the explicit scheduling grant rejection comprises at least one of the following: a scheduling request received by the serving cell from the user device that requests a resource; and a buffer status report received from the user device that indicates data for transmission to the serving cell.

According to an example implementation of the computer program product, the control information may include a first control information including a first scheduling grant that identifies a first downlink resource, the method further including: receiving, by the serving cell from the user device, a message rejecting the first scheduling grant; and controlling sending by the serving cell, a second control information including a second scheduling grant that identifies a second downlink resource to be used for downlink communication between the serving cell and the user device based on the user device rejecting the first scheduling grant.

According to an example implementation of the computer program product, the control information may include a first control information including a first scheduling grant that identifies a first resource, and the user device comprises a first user device; wherein the determining may include determining that the first user device has rejected the first scheduling grant; wherein the method further includes: increasing, by the serving cell, a priority of the first user device to receive scheduling grants, as compared to a priority of other user devices served by the serving cell; and controlling sending, by the serving cell, a second control information including a second scheduling grant that identifies a second resource to be used for communication between the serving cell and the first user device.

According to an example implementation of the computer program product, the method further including indicating, by the serving cell to the user device, that the scheduling grant can be rejected.

According to an example implementation of the computer program product, wherein the indicating may include at least one of: controlling sending, by the serving cell to the user device, a message via common signaling indicating that the scheduling grant can be rejected; and controlling sending, by the serving cell to the user device, a message via dedicated signaling indicating that the scheduling grant can be rejected.

According to an example implementation, an apparatus (500) may include: means (502A/502B, 504, 410) for controlling sending, by a serving cell, a control information including a scheduling grant that identifies a resource to be used for communication between the cell and a user device, wherein the scheduling grant may be rejected by the user device; and means (502A/502B, 504, 420) for determining by the serving cell whether or not the scheduling grant has been rejected by the user device.

According to an example implementation of the apparatus, the control information may include a first control information including a first scheduling grant that identifies a first downlink resource, the apparatus further including: means (502A/502B, 504) for controlling receiving, by the serving cell from the user device, a message rejecting the first scheduling grant; and means (502A/502B, 504) for controlling sending by the serving cell, a second control information including a second scheduling grant that identifies a second downlink resource to be used for downlink communication between the serving cell and the user device based on the user device rejecting the first scheduling grant.

According to an example implementation of the apparatus, the scheduling grant may include a first scheduling grant that identifies a first uplink resource; wherein the means for determining may include means (502A/502B, 504) for determining that the user device has rejected the first scheduling grant including one or more of the following: means (502A/502B, 504) for determining, by the serving cell, that the user device did not use the first uplink resource to transmit data to the serving cell; and means (502A/502B, 504) for controlling receiving, by the serving cell from the user device, an explicit scheduling grant rejection that rejects the first scheduling grant.

According to an example implementation of the apparatus, the explicit scheduling grant rejection may include at least one of the following: a scheduling request received by the serving cell from the user device that requests a resource; and a buffer status report received from the user device that indicates data for transmission to the serving cell.

According to an example implementation of the apparatus, the control information may include a first control information including a first scheduling grant that identifies a first downlink resource, the apparatus further including: means (502A/502B, 504) for receiving, by the serving cell from the user device, a message rejecting the first scheduling grant; and means (502A/502B, 504) for controlling sending by the serving cell, a second control information including a second scheduling grant that identifies a second downlink resource to be used for downlink communication between the serving cell and the user device based on the user device rejecting the first scheduling grant.

According to an example implementation of the apparatus, the control information may include a first control information including a first scheduling grant that identifies a first resource, and the user device may include a first user device; wherein the means for determining may include means (502A/502B, 504) for determining that the first user device has rejected the first scheduling grant; wherein the apparatus further includes: means (502A/502B, 504) for increasing, by the serving cell, a priority of the first user device to receive scheduling grants, as compared to a priority of other user devices served by the serving cell; and means (502A/502B, 504) for controlling sending, by the serving cell, a second control information including a second scheduling grant that identifies a second resource to be used for communication between the serving cell and the first user device.

According to an example implementation of the apparatus, the apparatus may further include means (502A/502B, 504) for indicating, by the serving cell to the user device, that the scheduling grant can be rejected.

According to an example implementation of the apparatus, means for indicating may include at least one of: means (502A/502B, 504) for controlling sending, by the serving cell to the user device, a message via common signaling indicating that the scheduling grant can be rejected; and means (502A/502B, 504) for controlling sending, by the serving cell to the user device, a message via dedicated signaling indicating that the scheduling grant can be rejected.

FIG. 5 is a block diagram of a wireless station (e.g., BS or user device) 500 according to an example implementation. The wireless station 500 may include, for example, two RF (radio frequency) or wireless transceivers 502A, 502B, where each wireless transceiver includes a transmitter to transmit signals and a receiver to receive signals. The wireless station also includes a processor or control unit/entity (controller) 504 to execute instructions or software and control transmission and receptions of signals, and a memory 506 to store data and/or instructions.

Processor 504 may also make decisions or determinations, generate frames, packets or messages for transmission, decode received frames or messages for further processing, and other tasks or functions described herein. Processor 504, which may be a baseband processor, for example, may generate messages, packets, frames or other signals for transmission via wireless transceiver 502 (502A or 502B). Processor 504 may control transmission of signals or messages over a wireless network, and may control the reception of signals or messages, etc., via a wireless network (e.g., after being down-converted by wireless transceiver 502, for example). Processor 504 may be programmable and capable of executing software or other instructions stored in memory or on other computer media to perform the various tasks and functions described above, such as one or more of the tasks or methods described above. Processor 504 may be (or may include), for example, hardware, programmable logic, a programmable processor that executes software or firmware, and/or any combination of these. Using other terminology, processor 504 and transceiver 502 together may be considered as a wireless transmitter/receiver system, for example.

In addition, referring to FIG. 5, a controller (or processor) 508 may execute software and instructions, and may provide overall control for the station 500, and may provide control for other systems not shown in FIG. 5, such as controlling input/output devices (e.g., display, keypad), and/or may execute software for one or more applications that may be provided on wireless station 500, such as, for example, an email program, audio/video applications, a word processor, a Voice over IP application, or other application or software.

In addition, a storage medium may be provided that includes stored instructions, which when executed by a controller or processor may result in the processor 504, or other controller or processor, performing one or more of the functions or tasks described above.

According to another example implementation, RF or wireless transceiver(s) 502A/502B may receive signals or data and/or transmit or send signals or data. Processor 504 (and possibly transceivers 502A/502B) may control the RF or wireless transceiver 502A or 502B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
controlling receiving, by a user device from a serving cell, a first control information including a scheduling grant that identifies a resource to be used for communication between the user device and the serving cell;
controlling receiving, by the user device, at least a part of a second control information from one or more other cells that are not serving the user device; and
determining, by the user device, whether or not to reject the scheduling grant from the serving cell based on at least the first control information received from the serving cell and the part of the second control information received from the one or more other cells that are not serving the user device.

2.-10. (canceled)

11. An apparatus comprising at least one processor and at least one memory including computer instructions, when executed by the at least one processor, cause the apparatus to:
control receiving, by a user device from a serving cell, a first control information including a scheduling grant that identifies a resource to be used for communication between the user device and the serving cell;
control receiving, by the user device, at least a part of a second control information from one or more other cells that are not serving the user device; and
determine, by the user device, whether or not to reject the scheduling grant from the serving cell based on at least the first control information received from the serving cell and the part of the second control information received from the one or more other cells that are not serving the user device.

12. The apparatus of claim 11 wherein causing the apparatus to determine comprises causing the apparatus to determine to reject the scheduling grant based on a conflict or overlap between the resource identified by the scheduling grant from the serving cell and a resource identified in the second control information from one or more of the other cells that are not serving the user device.

13. The apparatus of claim 11 wherein the scheduling grant identifies an uplink resource to be used for the user device to communicate with the serving cell;
wherein causing the apparatus to determine comprises causing the apparatus to determine to reject the scheduling grant;
wherein the apparatus being further configured to reject the uplink scheduling grant by the user device not transmitting data to the serving cell via the uplink resource identified by the scheduling grant.

14. The apparatus of claim 11 wherein the scheduling grant identifies an uplink resource to be used for the user device to communicate with the serving cell;
wherein the apparatus being configured to determine comprises the apparatus being configured to determine to reject the scheduling grant; and
wherein the apparatus is further configured to reject the uplink scheduling grant by the user device controlling sending a scheduling grant request or a buffer status report indicating data for transmission to the serving cell.

15. The apparatus of claim 11 wherein the scheduling grant identifies a downlink resource to be used for the user device to receive data from the serving cell;
wherein the apparatus being configured to determine comprises the apparatus being configured to determine to reject the scheduling grant; and
wherein the apparatus is further configured to reject the scheduling grant by the user device controlling sending a message rejecting the scheduling grant to the serving cell.

16. The apparatus of claim 11:
wherein the apparatus being configured to determine comprises the apparatus being configured to determine, by the user device, not to reject the scheduling grant from the serving cell; and
the apparatus being further configured to use, by the user device, the resource identified by the scheduling grant to communicate with the serving cell.

17.-22. (canceled)

23. A method comprising:
controlling sending, by a serving cell, a control information including a scheduling grant that identifies a resource to be used for communication between the cell and a user device, wherein the scheduling grant may be rejected by the user device; and
determining by the serving cell whether or not the scheduling grant has been rejected by the user device.

24.-31. (canceled)

32. An apparatus comprising at least one processor and at least one memory including computer instructions, when executed by the at least one processor, cause the apparatus to:
control sending, by a serving cell, a control information including a scheduling grant that identifies a resource to be used for communication between the cell and a user device, wherein the scheduling grant may be rejected by the user device; and
determine by the serving cell whether or not the scheduling grant has been rejected by the user device.

33. The apparatus of claim 32, wherein the control information comprises a first control information including a first scheduling grant that identifies a first downlink resource, the wherein causing the apparatus to determine comprises causing the apparatus to further perform:
control receiving, by the serving cell from the user device, a message rejecting the first scheduling grant; and
control sending by the serving cell, a second control information including a second scheduling grant that identifies a second downlink resource to be used for downlink communication between the serving cell and the user device based on the user device rejecting the first scheduling grant.

34. The apparatus of claim 32 wherein the scheduling grant comprises a first scheduling grant that identifies a first uplink resource;
wherein causing the apparatus to determine comprises causing the apparatus to determine that the user device has rejected the first scheduling grant based on one or more of the following:
causing the apparatus to determine, by the serving cell, that the user device did not use the first uplink resource to transmit data to the serving cell; and
causing the apparatus to control receiving, by the serving cell from the user device, an explicit scheduling grant rejection that rejects the first scheduling grant.

35. The apparatus of claim 33 wherein the explicit scheduling grant rejection comprises at least one of the following:
a scheduling request received by the serving cell from the user device that requests a resource; and
a buffer status report received from the user device that indicates data for transmission to the serving cell.

36. The apparatus of claim 34, wherein the control information comprises a first control information including a first scheduling grant that identifies a first downlink resource, the apparatus further comprising causing the apparatus to:
receive, by the serving cell from the user device, a message rejecting the first scheduling grant; and
control sending by the serving cell, a second control information including a second scheduling grant that identifies a second downlink resource to be used for downlink communication between the serving cell and the user device based on the user device rejecting the first scheduling grant.

37. The apparatus of claim 32 and further comprising causing the apparatus to indicate, by the serving cell to the user device, that the scheduling grant can be rejected.

38. The apparatus of claim 37 wherein causing the apparatus to indicate comprises cause the apparatus to perform at least one of:
control sending, by the serving cell to the user device, a message via common signaling indicating that the scheduling grant can be rejected; and
control sending, by the serving cell to the user device, a message via dedicated signaling indicating that the scheduling grant can be rejected.

39.-45. (canceled)
